(19) United States
(12) Patent Application Publication
(10) Pub. No.: US 2004/0107283 A1
(43) Pub. Date: Jun. 3, 2004

(54) SYSTEM AND METHOD FOR THE AGGREGATION AND MATCHING OF PERSONAL INFORMATION

(75) Inventor: Tom Paddon, San Diego, CA (US)

Correspondence Address: DALINA LAW GROUP, P.C., 7910 IVANHOE AVE. #325, LA JOLLA, CA, 92037, US

(73) Assignee: TRILIBIS INC., San Diego, CA (US)

(21) Appl. No.: 10/605,532

(22) Filed: Oct. 6, 2003

(51) Int. Cl. G06F 15/16

(52) U.S. Cl. 709/229

(57) ABSTRACT

Embodiments of the invention enable users with communication devices to access profiles and perform matches on profiles aggregated from multiple independent computer systems regardless of communications device type or operating system and regardless of affiliate match server computer type, operating system or language. In addition, embodiments of the invention allow users to join groups based on static or dynamic physical location parameters and dial other users and send multi-media data without prior knowledge of a phone number.

### BACKGROUND OF INVENTION

1. Field of the Invention

Embodiments of the invention described herein pertain to the field of mobile communication devices and server systems. More particularly, embodiments of the invention enable users with communication devices to access profiles and perform matches on profiles aggregated from multiple independent computer systems. In addition, embodiments of the invention allow users to join groups based on location parameters and connect to or dial other users by alias without knowledge of a machine address or phone number.

2. Description of the Related Art

Match based services provide users with a mechanism for locating other users that meet a certain set of criteria. For instance, a user interested in finding someone who studies yoga and lives or works with 5 miles from where the user lives could use a match based service to accomplish this task. Current match based services use proprietary systems that function independent of one another. Thus a user that belongs to one matching service has not necessarily registered with other matching services. When a match is not found by checking the records of one service, but could be found by checking another service, current systems are unable to find a match. This is largely because there is no common platform that allows users to locate matches within the proprietary systems that may be within acceptable ranges for parties from both systems.

In U.S. Pat. No. 6,052,122 to Sutcliffe, et al., a system is described that allows users to enter profiles and contact each other when a match is found. This system is based on newspaper match information and voicemail. Since this service is based on a diverse set of unformatted data fields, matching capabilities are limited.

In U.S. Pat. No. 6,549,768 issued to Fraccaroli, a centralized server architecture and location based matching system is described. This system uses the current cell of each user in order to perform a match. This system suffers from its inability to match users of disparate matching services or phone systems. Thus matching is limited to one phone service provider. Moreover, there is no provision for saving matches and later dialing the matches without knowing the phone number of the match or initiating phone calls by alias instead of phone number. No ability to join groups based on location or otherwise is contemplated in the patent.

In U.S. Pat. No. 5,086,394 issued to Shapira, a paging service is described for paging users when their profiles match. The Shapira system appears to require users to gather at a location where they can obtain a pager, enter their profile information and be paged when a match occurs. The Shapira system cannot operate independent of communications device, operating system, service provider, or match service and does not utilize external servers to provide matches independent of registered service.

Because of these and other limitations inherent in the design of current systems there is a need for an invention that enables matching services to occur across disparate systems using group and user profiles comprising location parameters and enabling simplified access to other users independent of machine addresses or phone numbers.

### SUMMARY OF INVENTION

Embodiments of the invention enable users with communication devices to access profiles and perform matches on profiles aggregated from multiple independent computer systems regardless of communications device type or operating system and regardless of affiliate match server computer type, operating system or language. In addition, embodiments of the invention allow users to join groups based on static or dynamic physical location parameters and dial other users and send multi-media data without a prior knowledge of the dialed phone number.

Embodiments of the invention utilize information from each user in the form of a profile containing metadata. Examples of the type of metadata that comprises a profile include various categories of information describing a group or the user, the user's groups and the user's preferences including filters for calculating matches with other user profiles and groups. Profiles are typically stored on a community engine server, but may also reside in distributed components configured to interface with the community engine server.

The community engine server has access to any computer server that chooses to affiliate itself with the system. Embodiments of the system obtain profiles from affiliated servers and transform them into a common format that can be readily cached and compared regardless of the format of the information on the affiliate server. One embodiment of the invention comprises a web service running on the affiliate server that passes back fields for use by the system. The transformed profiles may be cached in the community engine server for quick comparison without the need to remotely access the affiliated servers for each comparison. This speeds the matching algorithm. Aggregating profiles from various affiliate servers allows more matches to occur compared to proprietary solutions that do not share information across servers.

The community engine server may run on a single CPU server or utilize highly scalable architectures including but not limited to application servers running on load balanced clusters with database connection pools and using servlets, JSPs, EJBs, or .NET components with high speed and redundant routers. Embodiments may use any architecture that will handle the desired user load.

When a user accesses the system via a communications device, an application running on the communications device connects to the community engine server. The server performs commands activated by the user including, but not limited to updating the user's profile, accessing groups of users with similar interests and/or locations, updating a user's filter, checking for matches, creating new groups, and/or accessing lists of blocked users. In addition, the user can selectively initiate a filter operation, or the community engine can perform match operations continuously in the background in order to filter the user and group profiles in the community engine server and alert the user to a match.

Users can join groups based on like interests and the results of filtering. A user's physical location, for instance, can define the groups that a user may join. The location parameter can be tied to a city or zip code, or can be based on the user's dynamic physical position. The user can call or initiate multimedia transfers to other users in their groups, users N-degrees of freedom outside of their groups or other users that have come about by a match based on the user's filters. N may be configured to any depth or numeric value. For example, a user can call a friend of a friend, or a friend of a friend of a friend for 2 and 3 degree of freedom references respectively. Calling another user is accomplished by choosing the user's alias instead of dialing a phone number. Embodiments of the invention may never show or directly utilize a phone number in order to place a call. This is performed by storing metadata for the connection associated with calling a service or user in the community engine server or in the communication device itself. When the alias icon, image or text based representation is asserted, the communication device transfers the phone number, IP address or other machine related address to the cell or communication gateway to initiate a call or connection. An example multimedia transfer may entirely bypass the cell system and rely on a WiFi connection to an IP address that is represented by a user or group icon or picture.

A communications device as referenced herein signifies any electronics device capable of communicating with another electronic device. Examples of communication devices include but are not limited to cell phones, pagers, PDAs and network enabled computers such as PCs. Some communication devices may transfer data directly to another communications device. This would allow for the communication device to share profile and group information for a user, so that another user could obtain lists of groups or other users that are known to one user. Bluetooth, RF or IR based technology can be used to facilitate a direct transfer. Indirect transfers can occur via the community engine server. An example of an indirect transfer would be that of a user sharing his group list with a second user by enabling sharing of the profile on the community engine server so that the second user could access the group list.

An alias as referenced herein refers to an alphanumerical, icon or picture representation of a communications link, such as a phone number. Aliases may be used in order to initiate communications with another user without dialing a phone number, selecting a frequency or IP address or in any other way specifying the identification number of a machine.

### BRIEF DESCRIPTION OF DRAWINGS

FIG. 1 is an architectural view of an embodiment of the invention.

FIG. 2 shows an XML message comprising a profile.

FIG. 3 shows a method used by an embodiment the invention for initial startup and comparison of profiles.

FIG. 4 shows a method used by an embodiment of the invention for inviting a user to join a group based on the user's static or dynamic physical location.

### DETAILED DESCRIPTION

Embodiments of the invention enable users with communication devices to access profiles and perform matches on profiles aggregated from multiple independent computer systems regardless of communication device type or operating system and regardless of affiliate match server computer type, operating system or language. In addition, embodiments of the invention allow users to join groups based on static or dynamic physical location parameters and dial other users and send multi-media data without a prior knowledge of the dialed phone number.

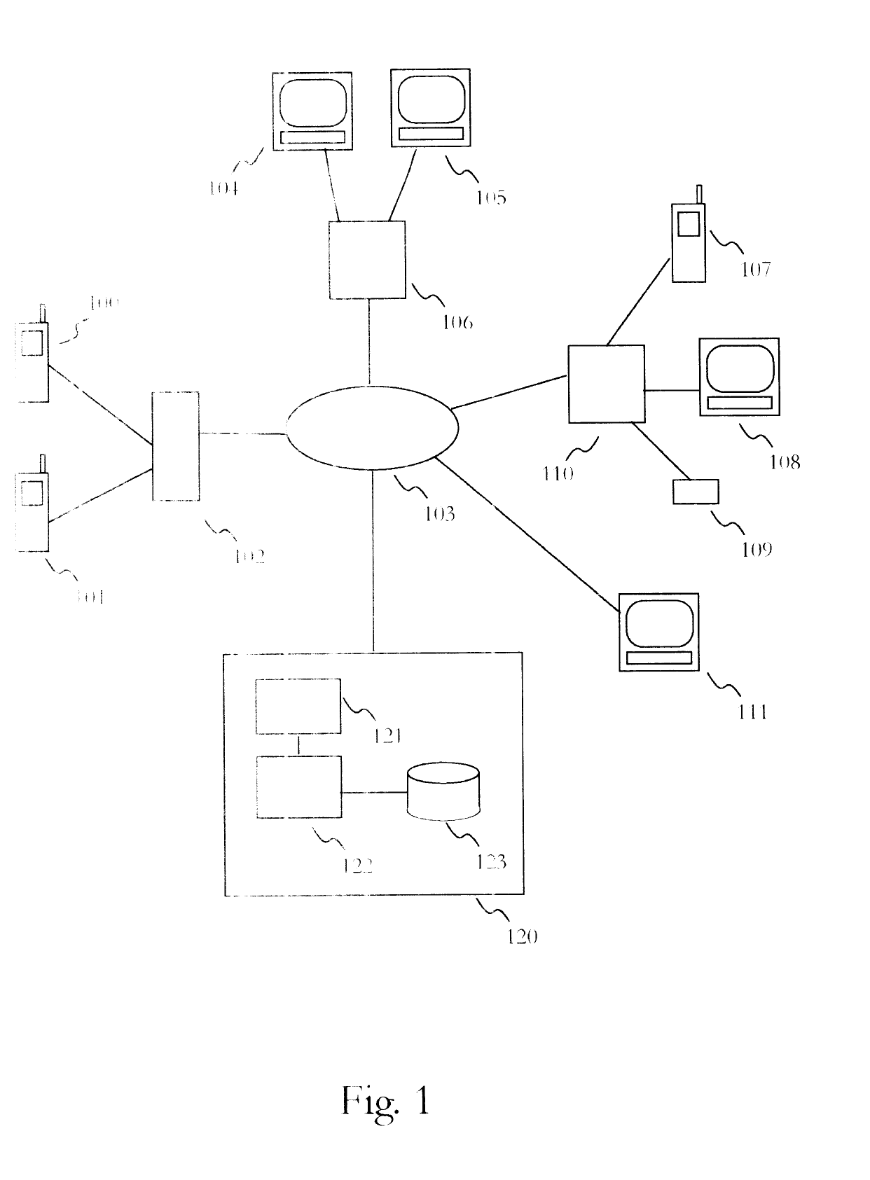

FIG. 1 shows an architectural view of an embodiment of the invention. Cell phone 100 and 101 communicate with each other and other cell phones via cell gateway 102. Cell gateway 102 connects the phone system to internet 103. A first affiliate match server 106 is used by registered users via computers 104 and 105. A second affiliate match server 110 is accessed via PDA 107, computer 108 and pager 109 in order to search and respond to matches found solely on second affiliate match server 110. First affiliate match server 106 and second affiliate match server 110 contain proprietary profiles in general containing different fields in different formats from multiple independent users of each respective system. Filter functions and resulting matches on one system are independent of matches on the other system even though two users of each respective system may be in fact standing next to one another.

Community engine server 120 stores user information in the form of a profile. Profiles are made up of metadata containing, for example, various categories of information describing the user, the user's groups and the user's preferences including a filter for matching other user profiles. Profiles may be accessed via internet 103 by computer 111 or by cell phone users 100 and 101 after passing through cell gateway 102. Embodiments of the invention may allow users of affiliate servers access via computers 104, 105, 108, PDA 107 and pager 109 as well. Community engine server may comprise web server 121, application server 122 and database server 123.

Community engine server 120 has access to any computer server that chooses to affiliate itself with the system such as first affiliate match server 106 and second affiliate match server 110. Embodiments of the invention obtain profiles from affiliate match servers and transform them into a common format that can be readily cached and compared regardless of the format of the information on the affiliate server. XML may be utilized in embodiments of the invention. XSLT (XML Stylesheet Language Transformations) may be utilized for converting one XML profile into another one obeying a different schema. Returning only those fields that are required by the community engine server matching functions also minimizes security issues with some of the fields of the user profiles since they may contain sensitive data. For example, an affiliate profile may contain fields such as social security number or credit card information that may not be used by the community engine server for matching operations and therefore do not need to be transferred to the community engine server. Some of the data on an affiliate match server may not be required on community engine server in order to perform matching functions and may therefore be eliminated from messages traveling to community engine server 120. An embodiment of the invention comprises a web service running on an affiliate match server that only passes back fields needed by the system. Data flowing from affiliate match servers 106 and 110 to community engine server 120 may be encrypted. The transformed profiles may be cached in community engine server 120 for quick comparison without the need to remotely access affiliated match servers 106 and 110 for each comparison. The comparison operations can be synchronously initiated as when a user accesses the system, or asynchronous and running on the community engine server in the background, alerting users when a user or group match has occurred. Aggregating profiles from various affiliate match servers increases the probability of a match compared to proprietary solutions that do not share information across each service.

The process of performing matches may comprise obtaining a profile and transforming it into a format known to community engine server 120, caching the profile for local access or alternatively accessing a group profile on community engine server 120, comparing the user profile to a second profile or group profile and determining whether enough of the fields match for a positive match to occur.

When a user accesses the system via a communications device, for example cell phone 100, an application running on communications device 100 connects to community engine server 120. Community engine server 120 performs commands activated by the user such as updating the user's profile, accessing groups of users with similar interests and/or locations, updating a user's filter, checking for matches, creating new groups, accessing lists of blocked users. Community engine server 120 contains data associated with a user. Embodiments of the invention allow users of affiliated match servers to gain access to matches from other services using interfaces in their own applications running in computer 104, 105 or PDA 107, computer 108 or pager 109 with the comparison process occurring on community engine server 120 since it contains profiles from the various affiliates. Cell phones 100 and 101 may be used in order to access the same data although the viewing areas of each device may be of different size and resolution.

Users can join groups based on like interests and results of the filtering of the user's profiles compared to other user or group profiles. A user's physical location, for instance, can define the groups that a user may join. This location parameter can be tied to a city or zip code, or based on the user's dynamic physical position. Cell gateway 102 and devices equipped with various positioning technologies such as GPS can communicate their position to community engine server 120. For profiles configured for dynamic physical location comparisons, matches and group invitations may be sent to cell phone 100 or PDA 107 or any other communications device alerting the user to the item of close physical location. The user can accept an invitation to join a group, and thus obtain a list of all users in that group in a particular area. In addition, while the user is moving about and comes within a definable distance from another user, the other user's groups may be available for the moving user to join. For static physical location applications, zip code or city code can be used in place of the dynamic physical location of the communications device. Both static and dynamic physical location dependent match criteria may be utilized at the same time. For example, this would enable a user to accept invitations to a new group in that user's city or when that user was passing through a distant area close to a group comprising at least one location or area. The user may be queried when within a configurable distance from a given point as to whether or not to join the group. The user can call other users in their groups by choosing the user's alias instead of dialing a phone number, or ever knowing the phone number at all. Since the phone number, IP address or other machine address is stored in either the communication device or community engine server as per the profile of the matched user or group, the number can be substituted for the alias where needed in order to initiate a communication link. For example, if a user were to select an alias in the form of a picture of someone in a group list, the metadata associated with the picture would be used in order to initiate a call. The phone number may be sent from the communication device to cell gateway 102 in order to place a call in this example. Text messages, videos, audio clips or any other form of multi-media may also be sent to an alias without dialing a phone number. By allowing users to access other members of the group and members of groups that these users belong to, an N-degree of separation group chain can be traversed without knowledge of machine addresses or phone numbers.

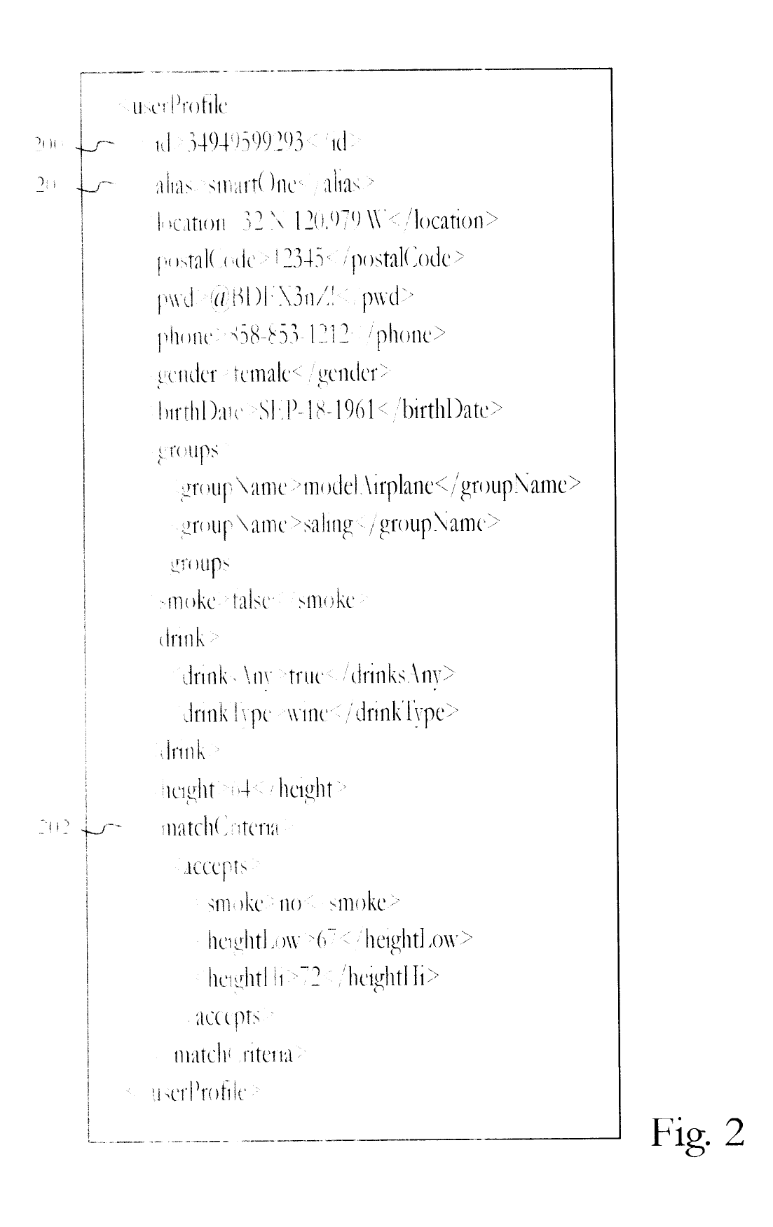

FIG. 2 shows an embodiment of a profile in XML format. Internal identifier 200, alias 201 and matchCriteria 202 are show along with the user's date of birth, gender, drinking and smoking preferences and location. One skilled in the art will recognize that the fields listed can be modified, reduced or increased in order to provide the desired searching capabilities on the data for matching functions. Embodiments of the invention may include matchCriteria in the profile or in a separate XML message. MatchCriteria may include ranges of age, ranges of size, ranges of weight and any other configurable parameters that include flags defining whether a particular fields is a to be excluded, thereby bypassing a match on that particular field.

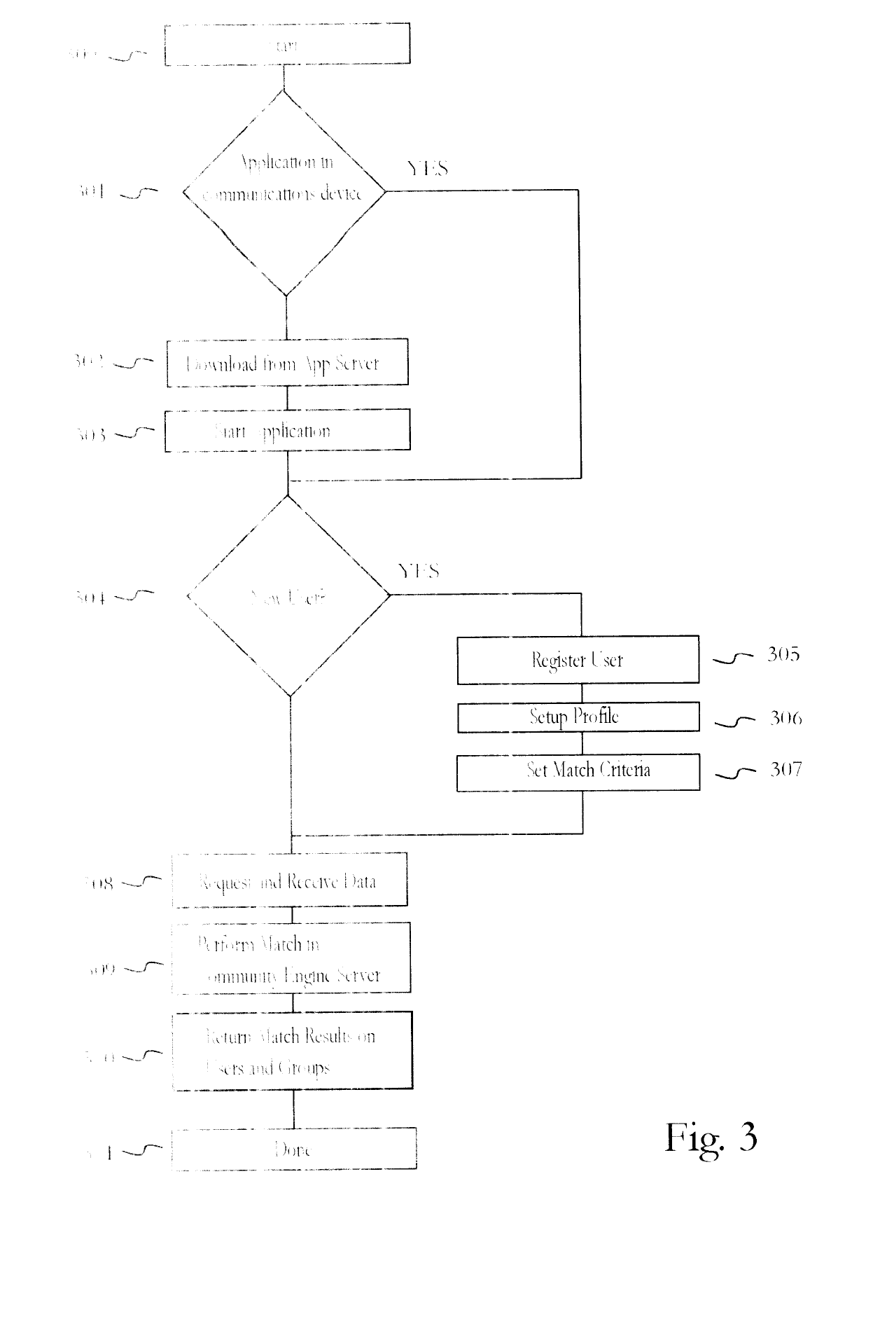

FIG. 3 shows a method used by an embodiment the invention for initial startup and comparing two profiles. Any field that is to be excluded as defined by a user is not used in that comparison. Comparisons may be one-way or two-way comparisons. The method of comparison may be configured by the user. A one-way comparison for performing matches on the “shopping” portion of the profile would allow users to buy something from someone without any matching function being applied back to the person looking for an item. A two-way comparison for dating profiles would ensure that for the defined parameters, both parties would require a match before notifying either user. Embodiments of the invention may use either technique in inviting users to join groups. For example, a sail boat group may use the users profile to determine if the user has an interest in sailing before inviting the user to join the group. The user initiates processing at Start 300. If the application is not in the communications device at 301, then the application is downloaded into the communications device at 302. The application is started at 303. If the user is new at 304 then the registration process takes place at 305 including setup of the profile at 306 and setup of the match criteria for matching against users and/or groups at 307. The application notifies the community engine server at 308 by sending the updated information. The community engine server performs the match at 309 and returns any groups or users that match the user's profile at 310. The process completes at 311. At this point the user can choose to initiate contact, edit the profile or matching criteria, block users or perform any other function the communications device is capable of including but not limited to sending multimedia to an alias of a user or to a group.

FIG. 4 shows a method used by an embodiment of the invention for inviting a user to join a group based on the user's static or dynamic physical location. As users move about, they come within configurable range of other users. Each user can be part of a number of groups, and may indeed form their own groups that may be configured to comprise at least one location. As users move to within a configurable range of a group, a notification signal, wakeup or visual signal can be asserted in order to alert the user to the possibility of joining a group. For example, this would allow someone on vacation to find an automobile club and access the members of the list in order to find out where the club believes the best repair facilities to be located. Many other possibilities exist and can increase the user's ability to gather information from a knowledgeable group that is familiar with an area or topic.

The process begins at 400, the user profile is checked in order to determine if dynamic location comparisons are to be performed at 401. If so, the communications device obtains its current location at 402 and notifies the community engine server of the location at 403. Embodiments of the invention may take full advantage of different techniques in order to calculate the location. For instance the system can utilize the phone network or triangulation unbeknownst to the communications device itself. If dynamic location matching is not enabled, the user's postal code or city is used as the current profile location. Embodiments of the invention may check all groups known to the community engine server to determine if they are near the current profile location at 404 or may also check all users and their associated groups within an area to determine if there is a possible match. A group associated with a user, or simply a group within a range of the current user is checked to determine if the group is something the user would be interested in at 405. The user is also checked by embodiments of the invention utilizing two-way matching to determine if the user should be invited into the group based on the user's profile at 406. If there is a match, the user is notified at 407. The process completes at 408.

Once a match has occurred or after the user has simply looked up another user from a group of by alias name, embodiments of the invention allow for communicating with a user through use of an alias without prior knowledge of a phone number. When accessing the group portion of the system, embodiments of the invention allow users to simply assert a connection to an alias in order to activate communications to another user. This eliminates the need to use a phone number, know a phone number, save a phone number or in any other way interact with a phone number.

Thus embodiments of the invention directed to a System and Method for the Aggregation and Matching of Personal Information have been exemplified to one of ordinary skill in the art. In the exemplary description given herein numerous specific details are set forth in order to provide a more thorough understanding of embodiments of the invention. It will be apparent, however, to an artisan of ordinary skill that the present invention may be practiced without incorporating all aspects of the specific details described herein. The elements described herein are examples that can in some instances be varied to any degree that enables the invention to accomplish the function for which it is designed. In other instances, features well-known to those of ordinary skill in the art have not been described in detail so as not to obscure the invention. Although examples of the invention are set forth herein, the claims, and the full scope of any equivalents, are what define the metes and bounds of the invention.

What is claimed is:

1. A system comprising:
a first communication device associated with a first user wherein said first communication device has a physical location parameter and is configured to communicate with a second communications device associated with a second user;
a community engine server comprising a profile associated with said first user wherein said community engine server is configured to compare said profile with at least one affiliate profile and obtain a match result; and,
at least one affiliate server comprising said at least one affiliate profile associated with an affiliate user wherein said at least one affiliate server is configured to provide said at least one affiliate profile to said community engine server over a communication network.

2. The system of claim 1 wherein said first communication device is configured to transfer information with said second communication device upon selection of an alias associated within N-degrees of freedom of said match.

3. The system of claim 1 wherein said first communication device is configured to allow a user to join a group based on said physical location parameter of said first communication device.

4. The system of claim 1 wherein said first communication device is configured to transfer information directly with said second communications device.

5. The system of claim 1 wherein said first communications device is configured to transform information indirectly with said second communications device.

6. The system of claim 1 wherein said physical location parameter is a static postal code.

7. The system of claim 1 wherein said physical location parameter is a dynamic physical location of said first communication device.

8. The system of claim 1 wherein said communications network comprises a web service.

9. The system of claim 1 wherein said community engine server comprises a scalable architecture.

10. A system comprising:
a first communication device associated with a first user wherein said first communication device comprises a physical location parameter and is configured to communicate with a second communication device associated with a second user by asserting an alias associated within N-degrees of freedom of said first user and further configured to allow said first user to join a group based on said physical location parameter of said first communications device;
a community engine server comprising a profile associated with said first user wherein said community engine server is configured to compare said profile with at least one affiliate profile and obtain a match result; and,
at least one affiliate server comprising said at least one affiliate profile associated with an affiliate user wherein said affiliate server is configured to provide said at least one affiliate profile to said community engine server over a communication network.

11. The system of claim 10 wherein said first communication device is configured to transfer information directly with said second communication device.

12. The system of claim 10 wherein said first communication device is configured to transfer information indirectly with said second communication device.

13. The system of claim 10 wherein said physical location parameter is a static postal code.

14. The system of claim 10 wherein said physical location parameter is a dynamic physical location of said first communication device.

15. The system of claim 10 wherein said communication network comprises a web service.

16. The system of claim 10 wherein said community engine server comprises a scalable architecture.

17. A method comprising:
obtaining an affiliate profile from an affiliate server;
transforming said affiliate profile to a transformed affiliate profile;
caching said transformed affiliate profile in a cache in a community engine server;
accessing a first user profile in said community engine server;
comparing said first user profile to said transformed affiliate profile; and,
generating a match result based on said comparing.

18. The method of claim 17 wherein said obtaining said affiliate profile comprises accessing a web service hosted on said affiliate server from said community engine server.

19. The method of claim 17 wherein said transforming further comprises the use of XSLT.

20. The method of claim 17 wherein said caching further comprises accessing a database.

21. The method of claim 17 wherein said accessing is based upon a user associated with said first user profile manipulating a communication device interface.

22. The method of claim 17 wherein said comparing is performed within at least one group associated with said first user profile.

23. The method of claim 17 wherein said comparing is performed based on a physical location parameter of a communication device.

24. The method of claim 17 wherein said generating is performed when a user associated with said first user profile accesses said community engine server.

25. The method of claim 17 wherein said generating is performed asynchronously by said community engine server.

26. A method comprising:
accessing a first user profile in a community engine server;
accessing a group profile in said community engine server;
comparing said first user profile to said group profile in said community engine server; and,
generating a match result based on said comparing.

27. The method of claim 26 further comprising:
inviting a user to join a group associated with said group profile based on said match result.

28. A method comprising:
accessing a first user profile in a community engine server;
accessing a second user profile in said community engine server;
comparing said first user profile to a group profile associated with said second user profile in said community engine server; and,
generating a match result based on said comparing.

29. The method of claim 28 further comprising:
inviting a user to join a group associated with said group profile based on said match result.

30. A system comprising:
means for obtaining an affiliate profile from an affiliate server;
means for transforming said affiliate profile to a transformed affiliate profile;
means for caching said transformed affiliate profile in a cache in a community engine server;
means for accessing a first user profile in said community engine server;
means for comparing said first user profile to said transformed affiliate profile; and,
means for generating a match result based on said comparing.

31. A system comprising:
means for accessing a first user profile in a community engine server;
means for accessing a group profile in said community engine server;
means for comparing said first user profile to said group profile in said community engine server; and,
means for generating a match result based on said comparing.

32. The system of claim 31 further comprising:
means for inviting a user to join a group associated with said group profile based on said match result.

33. A system comprising:
means for accessing a first user profile in a community engine server;
means for accessing a second user profile in said community engine server;
means for comparing said first user profile to a group profile associated with said second user profile in said community engine server; and,
means for generating a match result based on said comparing.

34. The system of claim 33 further comprising:
means for inviting a user to join a group associated with said group profile based on said match result.
